(19) United States
(12) Patent Application Publication
(10) Pub. No.: US 2026/0178750 A1
(43) Pub. Date: Jun. 25, 2026

(54) IMAGE SEARCH SYSTEM FOR INTEGRATING OBJECT DETECTION AND IMAGE-TO-SEMANTIC SEARCH MECHANISM

(71) Applicant: Realtek Semiconductor Corp, HsinChu (TW)

(72) Inventor: Hung-Ying Chen, HsinChu (TW)

(73) Assignee: Realtek Semiconductor Corp, HsinChu (TW)

(21) Appl. No.: 19/408,289

(22) Filed: Dec. 3, 2025

(30) Foreign Application Priority Data
Dec. 25, 2024 (TW) 113150680

(51) Int. Cl. G06F 21/60; G06F 16/732; G06V 10/94; G06V 20/40

(52) U.S. Cl. CPC G06F 21/602; G06F 16/7335; G06V 10/95; G06V 20/41; G06V 20/46

(57) ABSTRACT

An image search method includes: providing a human-machine interface to receive an input of a user; performing an image object detection operation according to the input of the user sent from the human-machine interface to generate a specific image; performing an image-to-semantic operation based on the specific image to perform an irreversible encryption encoding upon the specific image to generate a specific semantic vector; sending the generated specific semantic vector into a cloud semantic search engine of a cloud server so that the cloud semantic search engine searches multiple semantic vectors stored in the cloud server according to the specific semantic vector so as to select image information corresponding to an approximate semantic vector and send the image information into the human-machine interface; and, controlling the human-machine interface to display the image information for the user.

### BACKGROUND OF THE INVENTION

### 1. Field of the Invention

The invention relates to an image search system, and more particularly to an electronic device and an image search method.

### 2. Description of the Prior Art

Generally speaking, when a traditional method executes an image search task, in order to ensure the quality of search results, its processing operations usually involve extensive feature extraction, collection, and comparison of image pixel-level features. Since such computations typically require significant processing power and more input/output (I/O) operations, the computations are usually executed on the server side. As a result, the overall search process inevitably involves transmitting the data of raw images into the server side. However, a conventional image search system that requires transmitting the data of raw images into the server side has two major drawbacks.

The first drawback is the user privacy. The aforementioned image search system involves transmitting raw images into the server side, and the raw images may contain sensitive (or non-sensitive) personal information such as personal photos, identifiable details, and/or interior images of the user's residence. During the transmission process from the user's device into the server side and being processed on the server side, the user's sensitive information is at risks of interception, theft, or unauthorized access, and this raises the possibility of potential privacy leakages. Regardless of whether an access is legal or illegal, any potential security vulnerability may lead to personal privacy being exposed and cause a negative impact on the personal safety or trust system.

The second drawback is the high cost of server deployment and maintenance. As previously mentioned, since extensive image feature extraction and search computations are executed and concentrated on the server side, the requirements of hardware components on the server side are quite high. The server must have strong processing capabilities, large storage capacity, and an efficient I/O system, to support high-concurrency image search requests. This significantly increases the cost of server construction and maintenance, which may include hardware acquisition, power consumption, and technical personnel expenses. Additionally, the excessive server loads may cause performance bottlenecks or even system failures, and may further increase operational risks for the service providers.

Traditional technical approaches are provided to solve only some problems. However, if server-side security measures are inadequate and encryption keys are compromised or leaked, the privacy risks associated with raw images cannot be fully eliminated. Furthermore, these traditional technical approaches may reduce the accuracy and effectiveness of image searches, and force the user to balance the performance of privacy protection and search performance. Even though the user may apply mosaic processing to mask private information, this method has limitations as it removes critical features during the masking process, and this will reduce the accuracy and reliability of search results. In other words, the existing traditional technical approaches may increase the burden and potential security risks on the server side and also diminish the effectiveness and precision of search operations. These issues make the existing traditional technical approaches have a great challenge to strike a balance between privacy protection and search performance.

### SUMMARY OF THE INVENTION

Therefore one of the objectives of the invention is to provide an electronic device and an image search method (or system) to solve the above-mentioned problems.

According to embodiments of the invention, an electronic device is disclosed. The electronic device comprises a human-machine interface, an object detection circuit, an image-to-semantic circuit, and a central controller. The human-machine interface is used for receiving an input of a user. The object detection circuit is used for performing an image object detection operation. The image-to-semantic circuit is used for performing an image-to-semantic operation. The central controller is coupled to the human-machine interface, the object detection circuit, and the image-to-semantic circuit. The central controller controls the object detection circuit to perform the image object detection operation to generate a specific image based on the input of the user transmitted from the human-machine interface and sends the specific image into the image-to-semantic circuit to control the image-to-semantic circuit to perform the image-to-semantic operation to perform an irreversible encryption encoding upon the specific image to generate a specific semantic vector. The image-to-semantic circuit sends the generated specific semantic vector into a cloud semantic search engine of a cloud server remotely connected to the electronic device, to make the cloud semantic search engine search for multiple semantic vectors stored in the cloud server based on the specific semantic vector so as to select an approximate semantic vector corresponding to an image information and image information corresponding to the approximate semantic vector back to the central controller of the electronic device. The central controller sends the image information to the human-machine interface to make the human-machine interface display the image information for the user.

According to the embodiments, an image search method of an electronic device is disclosed. The method comprises: providing a human-machine interface to receive an input of a user; controlling an object detection circuit to perform an image object detection operation according to the input of the user transmitted from the human-machine interface to generate a specific image; sending the specific image into an image-to-semantic circuit to control the image-to-semantic circuit to perform an image-to-semantic operation to perform an irreversible encryption encoding upon the specific image to generate a specific semantic vector; sending the generated specific semantic vector into a cloud semantic search engine of a cloud server remotely connected to the electronic device, to make the cloud semantic search engine search for multiple semantic vectors stored in the cloud server based on the specific semantic vector so as to select an approximate semantic vector corresponding to an image information and sends image information corresponding to the approximate semantic vector to the human-machine interface; and, controlling the human-machine interface to display the image information for the user.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of an image search system according to an embodiment of the invention.

FIG. 2 is a schematic diagram of the operation flow of the image search system as shown in FIG. 1 according to an embodiment of the invention.

FIG. 3 is another example schematic diagram of the object detection circuit as shown in FIG. 1 according to another embodiment of the invention.

FIG. 4 is another example schematic diagram of the image-to-semantics circuit as shown in FIG. 1 according to another embodiment of the invention.

FIG. 5 is a schematic diagram of the operation flow of the image search system as shown in FIG. 1 which is used as a video search system according to another embodiment of the invention.

FIG. 6 is an example schematic diagram of the object detection circuit when the image search system operates as a video search system according to another embodiment of the invention.

### DETAILED DESCRIPTION

The present invention aims at providing a privacy-preserving and high-efficiency interactive search system which integrates object detection and image-to-semantic search mechanism and methods to simultaneously achieve the user privacy protection, improve search efficiency, and to enhance the image search quality.

Specifically, embodiments of the invention disclose an image (or image object) search system. At the first, for the user privacy protection, the image search system utilizes an artificial intelligence-based semantic AI module (or circuit) to locally perform an irreversible encryption encoding upon data of the raw image on a local device (i.e. an edge device), to ensure that the data of the raw/original image can remain at an encrypted state throughout the transmission process and during the computation process in the cloud server, so as to effectively prevent the exposure of sensitive information. More specifically, the image is processed and encrypted in an encrypted representation on the user's device, and this representation does not contain identifiable image content. Thus, even though it is intercepted or the server side is under attack, the raw image cannot be reconstructed or recognized through such representation. This encryption method can eliminate potential privacy leakage issues and provide strong privacy protective measures for the user.

Secondly, for the search efficiency, the traditional image search method often needs to process the raw image on the server side and thus the search speed and efficiency will be slowed down due to the constraints of network transmission bottlenecks and server loadings. Compared to the traditional image search method, the disclosed image search system in the embodiments of the invention is used to extract and encode image semantic features in the local device, to significantly reduce the data amount that needs to be transmitted. This enhances the overall search efficiency of the system as well as ensures that the server side only needs to perform searches and matches the data of encrypted representations, thereby lowering the computational resource demands. Additionally, this design facilitates parallel processing, and further improves the search speed.

Furthermore, for the search quality, the image search system in the embodiments of the invention utilizes an object detection module which participates in decision-making based on AI (artificial intelligence) model(s), to detect objects within a specific image, identify the categories and attributes of the objects, and to generate semantic descriptions of these objects. Each specific object which is detected is assigned with detailed semantic information, to form structured descriptive data.

In comparison, the traditional image search method usually relies on searching or retrieving entire raw images based on pixel-level feature extraction and matching of pixels of the entire images. However, this traditional method has significant limitations and drawbacks, particularly in complex images containing multiple objects or complex/intricate background elements. In this situation, the pixel-level feature data of an entire image often becomes cluttered and imprecise, and which significantly reduce the relevance and accuracy of search results.

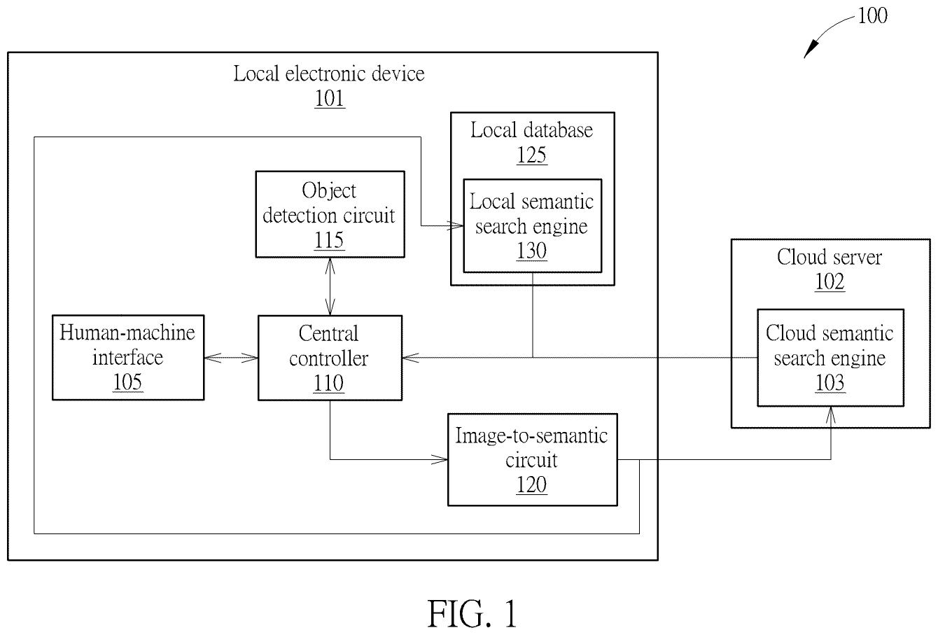

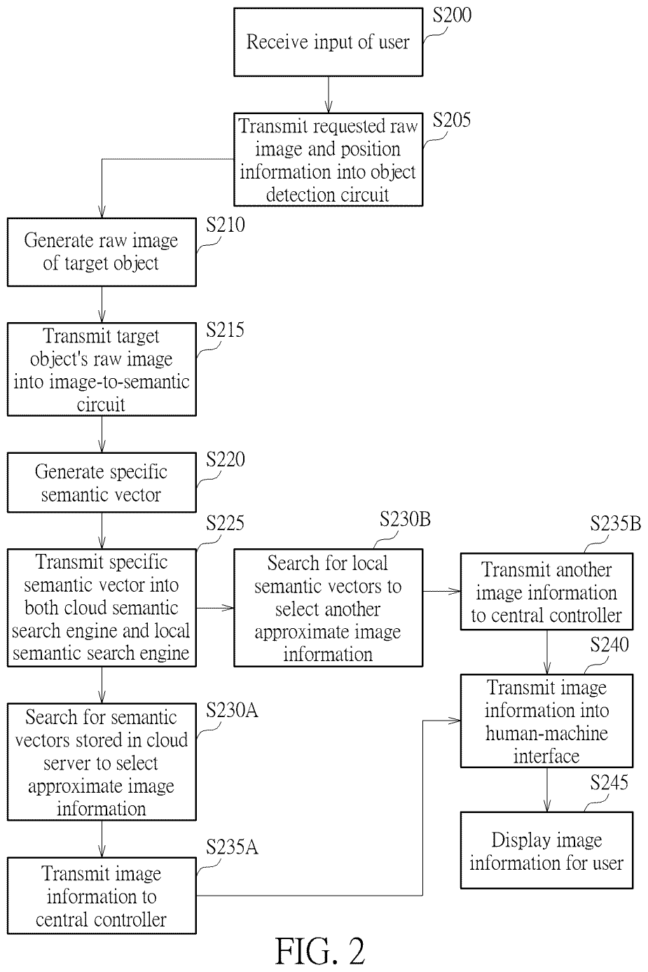

Refer to FIG. 1 in conjunction with FIG. 2. FIG. 1 is a block diagram of an image search system 100 according to an embodiment of the invention. FIG. 2 is a diagram illustrating the operation flow of the image search system 100 according to an embodiment of the invention. As shown in FIG. 1, the image search system 100 is implemented on a local electronic device 101 (e.g. an edge device) and comprises a human-machine interface 105, a central controller 110, an object detection module such as an object detection circuit 115, an image-to-semantic module such as an image-to-semantic circuit 120, a local database 125, and a local semantic search engine 130. The local semantic search engine 130 can be a semantic-based search engine. The electronic device 101 is externally connected to one or more cloud servers 102 via wired or wireless networks. The cloud server 102 comprises a cloud semantic search engine 103. It should be noted that, in one embodiment, the object detection module 115, image-to-semantic module 120, and local semantic search engine 130 can be implemented by either entirely as software programs or models or as a combination of software and hardware components.

The human-machine interface 105 is used for receiving an input of a user (Step S200 in FIG. 2), e.g. a search request. For example (but not limited), if the local device 101 is a television (TV) device, then the human-machine interface 105 may include a TV remote control device, and the user can input his/her search request through the TV remote control device to transmit the search request to the TV device.

The central controller 110 is coupled to the human-machine interface 105, object detection circuit 115, image-to-semantic circuit 120, and the local semantic search engine 130. The central controller 110 is used for controlling the overall operations of the image search system 100 and responsible for communicating data between the human-machine interface 105, object detection circuit 115, and image-to-semantic circuit 120. The local database 125 is used to store multiple local semantic vectors, and the local semantic search engine 130 is coupled to the local database 125.

The object detection circuit 115 is used to perform an image object detection operation. For example, the user's input includes information of a search request provided by the user, and such information comprises the requested raw image and position information such as the raw image selected by the user and the selected/touched picture position. The central controller 110 transmits the requested raw image and position information received from the human-machine interface 105 into the object detection circuit 115 (Step S205 in FIG. 2). The object detection circuit 115 for example may include an object detection model and is used for performing the image objection detection operation based on the raw image selected by the user and the selected picture position to extract a raw image of a target item (or a target object) so as to generate the raw image of the target object as a specific image generated by the image object detection operation (Step S210). For instance, the object detection model may be a deep learning model used for object detection in computer vision, e.g. a YOLO-based model. The input to the object detection model can be an RGB color image (i.e., the raw image) at the picture position selected/touched by the user, and the image object detection operation can accordingly generate and output a target object's position in the picture position, an object position confidence level and the target object's category, to generate the raw image of the target object. In addition, the image objection detection operation can also change the sensitivity of the object detection model by controlling a threshold value for the object position confidence level. The central controller 110 then transmits the target object's raw image (i.e., the specific image) into the image-to-semantic circuit 120 (Step S215).

The image-to-semantic circuit 120 comprises an image semantic model and is used for performing the image-to-semantic operation to perform an irreversible encryption encoding upon the target object's raw image (i.e., the specific image) in the electronic device 101 to generate a specific semantic vector (Step S220). For example, the image semantic model extracts a feature vector of the target object as the specific semantic vector. Specifically, the image semantic model can be an artificial intelligence learning model which operates based on contrastive language-image pre-training (CLIP) algorithm. The input of the image semantic model can be an RGB color image, and the output of the image semantic model is a feature vector calculated and obtained for the input image. Additionally, the image semantic model can be trained by private data to enhance the strength of its irreversible encryption encoding. Next, the image-to-semantic circuit 120 transmits the specific semantic vector into both the cloud semantic search engine 103 in the cloud server 102 remotely connected to the electronic device 101 and the local semantic search engine 130 in the electronic device 101 (Step S225), to control and make the cloud semantic search engine 103 search for multiple semantic vectors stored in the cloud server 102 based on the specific semantic vector to select an approximate semantic vector (which is most similar to the specific semantic vector in the multiple semantic vectors) and corresponding image information (Step S230A); the image information represents the most similar image stored in the cloud server 102. Subsequently, the cloud server 102 transmits the retrieved image information corresponding to the approximate semantic vector back to the central controller 110 of the electronic device 101 (Step S235A). Then, the central controller 110 transmits the received image information into the human-machine interface 105 (Step S240), to make the human-machine interface 105 display the image information for the user (Step S245). More specifically, the cloud semantic search engine 103 is another semantic-based search engine and is used to provide search request(s) to the cloud server 102's database according to the feature vector (i.e., the specific semantic vector) of the target object encoded by the irreversible encryption encoding, and the cloud server 102 is a cloud service server which comprises a cloud database (not shown in FIG. 1) and is used for storing data and returns search results back to the central controller 110. Accordingly, the image search system 100 can present/display the resultant search result(s) for the user through the human-machine interface 105.

Additionally, in Step S225, the image-to-semantic circuit 120 can also send the generated specific semantic vector into the local semantic search engine 130, to control and make the local semantic search engine 130 compare the specific semantic vector with the multiple local semantic vectors stored in the local database 125 to identify and select another approximate/similar semantic vector and correspondingly retrieve another image information (Step S230B). Then, the local semantic search engine 130 transmits the another image information back to the central controller 110 (Step S235B). The central controller 110 subsequently transmits the another image information into the human-machine interface 105 (Step S240), and thus the human-machine interface 105 can simultaneously display both the image information retrieved from the cloud server 102 and the another image information retrieved locally from the local semantic search engine 130 for the user (Step S245).

Therefore, in the above embodiments, the encrypted feature vector of the target object is used to simultaneously submit search requests into both the local electronic device's database and the cloud server database. Both the local electronic device's database and the cloud server database for example can be vector databases, and the input can be a query of a feature vector to be searched while the output is the retrieved image result. These databases are used to store metadata of images and to store image feature vectors which are generated by using the above-mentioned image semantic circuit (or similar/same circuit). When a search request is submitted/provided, the cloud semantic search engine 103 and/or local semantic search engine 130 correspondingly is/are used to compute the similarities between the query feature vector and the feature vectors stored in the corresponding databases and to rank the computed similarities to obtain the approximate/similar semantic vector. The calculation of the similarities is executed based on cosine similarity or Euclidean distance.

For example (but not limited to), if the local electronic device 101 is a TV device, the human-machine interface 105 may include a TV remote control device and a display screen of the TV device. The user can use the TV remote control device to search for similar images, similar web texts, and/or similar videos stored locally in the TV device, and can also use the TV remote control device through the Internet to search for similar images, similar web texts, and/or similar videos stored in the cloud server. The human-machine interface 105 can ultimately display and present the resultant search results on the display screen to the user, and the resultant search results may include the similar images, web texts, and/or videos stored in both the TV device and/or the cloud server.

It should be noted that, in one embodiment, the local semantic search engine 130 and the local database 125 are optional. That is, in one embodiment, a local electronic device may exclude the local semantic search engine 130 and the local database 125. In this situation, the user can for example use the TV remote control device through the Internet to search for the similar images, web texts, and/or videos stored in the cloud server. The human-machine interface 105 for example displays and presents the resultant search results on the TV screen for the user, and in this situation the resultant search results may include only the similar images, web texts, and/or videos stored in the cloud server but do not include any images, web texts, or videos stored in the local electronic device 101.

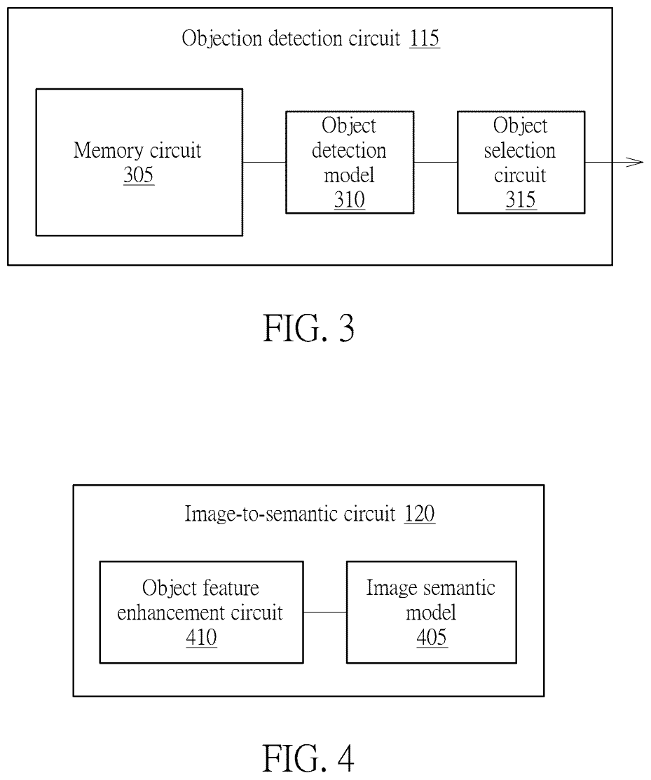

FIG. 3 is a schematic diagram illustrating another example of the object detection circuit 115 as shown in FIG. 1 according to another embodiment of the invention. As shown in FIG. 3, the object detection circuit 115 comprises a memory circuit 305, an object detection model 310, and an object selection circuit 315. The memory circuit 305 is for example a memory module and is used to store image information such as data of multiple raw image frames. The object detection model 310 for example is a deep learning model used for object detection in computer vision, and its input can be an RGB color image. The image object detection operation can accordingly generate and output the target object's position in the frame, an objection position confidence level, and the object's category, to generate the raw image of the target object. The object detection model 310 can extract and retrieve multiple adjacent raw images of the raw image from the memory circuit 305 based on the requested raw image and position information, and it extracts multiple objects' images corresponding to the position information respectively from the adjacent raw frames. The object selection circuit 315 subsequently selects the preferred/better object image from these multiple objects' images and outputs the preferred/better object image as the information of the specific image. When the object image quality of a target object currently selected by the user is poor, the object detection circuit 115 in this situation can use the target object's higher-quality object images in the other frames to improve the search accuracy. In other words, the object detection circuit 115 in this situation selects the highest-quality image of the target object among the searched images based on the temporarily stored past image information and current image information.

FIG. 4 is another example schematic diagram of the image-to-semantic circuit 120 shown in FIG. 1 according to another embodiment of the invention. As shown in FIG. 4, the image-to-semantic circuit 120 comprises an image semantic model 405 and an object feature enhancement circuit 410, and the object feature enhancement circuit 410 is coupled to the image semantic model 405. The object feature enhancement circuit 410 is used to preprocess the specific image to enhance the features of the specific image to improve the representativeness of the feature vectors generated by the image semantic model 405 for receiving the input image of target object. For example (but not limited to), the object feature enhancement circuit 410 can perform the image matting for the target object to remove the background image so as to extract the target object's image. The image semantic model 405 for example is an artificial intelligence learning model based on contrastive learning with images and texts. The input of the image semantic model 405 is an RGB color image, and its output is the feature vector computed for the input RGB color image. The image semantic model 405 is used to perform the irreversible encryption encoding upon the specific image, which has the enhanced features, to extract a feature vector (i.e., the enhanced feature vector) of the specific object as the specific semantic vector.

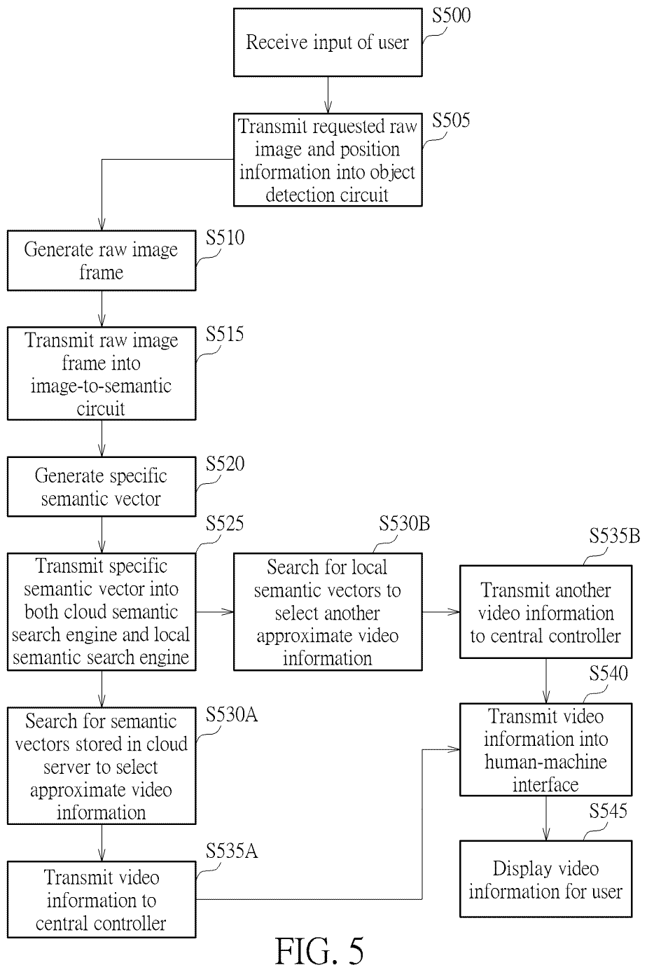

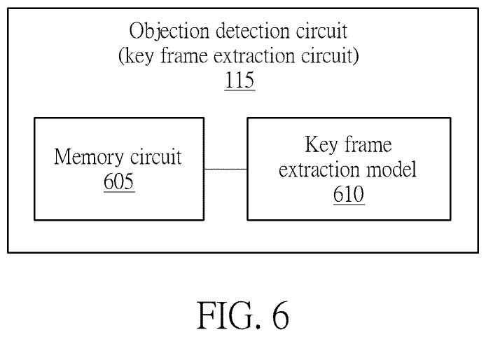

Additionally, in one embodiment, the image search system 100 in FIG. 1 can also be used as a video search system. Please refer to FIG. 5 in conjunction with FIG. 6. FIG. 5 is a schematic diagram of the operation flow of the image search system 100 of FIG. 1 used as a video search system according to another embodiment of the invention. FIG. 6 is a schematic diagram of the object detection circuit 115 when the image search system 100 is used as a video search system according to an embodiment of the invention. As shown in FIG. 5, in Step S500, the human-machine interface 105 is used to receive an input of a user. Then, in Step S505, the central controller 110 is arranged to transmit the request information (e.g. the requested raw image frame and position information) received from the human-machine interface 105 into the object detection circuit 115. In Step S510, the object detection circuit 115 performs an image object detection operation to extract the target object's raw image (or target item's image) to generate a raw image of the target object as the specific image produced by the image object detection operation. In this situation, the information of the specific image refers to an image frame, i.e., a picture of a raw image frame. In Step S515, the central controller 110 is arranged to transmit the raw image frame of the target object into the image-to-semantic circuit 120.

Similarly, the image-to-semantic circuit 120 uses the image semantic model to perform the image-to-semantic operation upon the s raw image frame of target object of the electronic device 101 to execute the irreversible encryption encoding so as to generate a specific semantic vector (Step S520). Then, the image-to-semantic circuit 120 sends the specific semantic vector into the cloud semantic search engine 103 of cloud server 102 remotely connected to the electronic device 101 and the local semantic search engine 130 (Step S525), to control and make the cloud semantic search engine 103 search for multiple semantic vectors stored in the cloud server 102 based on the specific semantic vector so as to select an approximate/similar semantic vector (the closest semantic vector to the specific semantic vector) and a corresponding video information (Step S530A). This video information is the most similar image video data stored in the cloud server 102, and it is then sent back to the electronic device 101's central controller 110 (Step S535A). Next, the central controller 110 is arranged to transmit the received video information into the human-machine interface 105 (Step S540), to control the human-machine interface 105 display and present the video information for the user (Step S545). Additionally, in Step S525, the image-to-semantic circuit 120 may simultaneously send the generated specific semantic vector into the local semantic search engine 130 to control and make the local semantic search engine 130 compare the local semantic vectors stored in the local database 125 with the specific semantic vector to select another approximate/similar semantic vector and another corresponding video information (Step S530B). The another corresponding video information will be sent back to the central controller 110 (Step S535B). The central controller 110 further sends the another corresponding video information into the human-machine interface 105 (Step S540). The human-machine interface 105 can accordingly display the video information and the another video information for the user (Step S545), i.e. it can simultaneously display and present the videos in the local device and in the could server, which are closest to the raw/original image frame(s), for the user.

As shown in FIG. 6, the object detection circuit 115 in this example is used as a key frame extraction circuit and includes a memory circuit 605 (e.g., a memory) and a key frame extraction model 610 which is coupled to the memory circuit 605. The memory circuit 605 is used to store previously stored image frame information and current image frame information. The key frame extraction model 610 based on the requested raw image frame extracts multiple adjacent raw image frames of the raw image frame from the memory circuit 605, and then selects a preferred/better raw image frame from the multiple adjacent raw image frames as the information of the specific image, i.e. selecting a raw image key frame as the information of the specific image. In this way, the central controller 110 can send the preferred/better raw image frame into the image-to-semantic circuit 120 to perform the irreversible encryption encoding upon the preferred/better raw image frame to generate the specific semantic vector. The image-to-semantic circuit 120 sends the generated specific semantic vector into the cloud semantic search engine 103 of the cloud server 102, which is remotely connected to the electronic device 101, to control the cloud semantic search engine 103 search for the multiple semantic vectors stored in the cloud server 102 based on the specific semantic vector so as to select an approximate semantic vector and a corresponding video information. The corresponding video information corresponding to the approximate semantic vector is transmitted to the central controller 110 of electronic device 101, and the central controller 110 can transmit the video information into the human-machine interface 105 to make the human-machine interface 105 display the video information for the user. Similarly, the comparison of semantic vectors can also be applied in the local database to compare feature vectors to perform the video search operation. Thus, by comparing the feature vector of the key frame image with the feature vectors of the video key frames stored in the local (or cloud) database, the video search operation can be achieved effectively.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device, comprising:
a human-machine interface, for receiving an input of a user;
an object detection circuit, for performing an image object detection operation;
an image-to-semantic circuit, for performing an image-to-semantic operation; and
a central controller, coupled to the human-machine interface, the object detection circuit, and the image-to-semantic circuit;
wherein the central controller controls the object detection circuit to perform the image object detection operation to generate a specific image based on the input of the user transmitted from the human-machine interface and sends the specific image into the image-to-semantic circuit to control the image-to-semantic circuit to perform the image-to-semantic operation to perform an irreversible encryption encoding upon the specific image to generate a specific semantic vector; the image-to-semantic circuit sends the generated specific semantic vector into a cloud semantic search engine of a cloud server remotely connected to the electronic device, to make the cloud semantic search engine search for multiple semantic vectors stored in the cloud server based on the specific semantic vector so as to select an approximate semantic vector corresponding to an image information and sends image information corresponding to the approximate semantic vector back to the central controller of the electronic device; and, the central controller sends the image information to the human-machine interface to make the human-machine interface display the image information for the user.

2. The electronic device of claim 1, further comprising:
a local database, for storing multiple local semantic vectors; and
a local semantic search engine, coupled to the local database;
wherein the image-to-semantic circuit further sends the generated specific semantic vector into the local semantic search engine, to make the local semantic search engine compare the multiple local semantic vectors stored in the local database based on the specific semantic vector to select another image information corresponding to another approximate semantic vector and send the another image information into the central controller; and, the central controller further sends the another image information into the human-machine interface, to make the human-machine interface display both the image information and the another image information for the user.

3. The electronic device of claim 1, wherein the input of the user comprises request information provided by the user, and the request information comprises a raw image and position information in the raw image requested by the user; and, the object detection circuit is used to perform the image object detection operation according to the requested raw image and the requested position information to extract an image of a specific object corresponding to the position information in the raw image as information of the specific image.

4. The electronic device of claim 1, wherein the image-to-semantic circuit comprises:
an object feature enhancement circuit; and
an image semantic model, coupled to the object feature enhancement circuit;
wherein the object feature enhancement circuit is used to enhance features of the specific image, and the image semantic model is used to perform the irreversible encryption encoding upon the enhanced specific image to extract a feature vector of the specific object as the specific semantic vector.

5. The electronic device of claim 1, wherein the input of the user comprises request information provided by the user, and the request information comprises a raw image and position information in the raw image requested by the user, and the object detection circuit comprises:
a memory circuit, for storing image information;
an object detection model, coupled to the memory circuit; and
an object selection circuit, coupled to the object detection model;
wherein the object detection model is used to extract multiple adjacent raw images from the memory circuit and extract multiple object images corresponding to the position information respectively in the multiple adjacent raw images to generate multiple object images based on the requested raw image and the requested position information; and, the object selection circuit is used to select a preferred object image from the multiple object images as information of the specific image.

6. The electronic device of claim 1, wherein the input of the user comprises request information provided by the user, and the request information comprises a raw image frame, and the object detection circuit comprises:
a memory circuit, for storing image frame information; and
a key frame extraction model, coupled to the memory circuit;
wherein the key frame extraction model based on the requested raw image frame extracts multiple adjacent raw image frames of the requested raw image frame from the memory circuit, and selects a preferred raw image frame from the multiple adjacent raw image frames as information of the specific image; the central controller sends the preferred raw image frame into the image-to-semantic circuit to control the image-to-semantic circuit to perform the image-to-semantic operation to perform the irreversible encryption encoding upon the preferred raw image frame to generate the specific semantic vector; the image-to-semantic circuit sends the generated specific semantic vector into the cloud semantic search engine of a cloud server remotely connected to the electronic device, to make the cloud semantic search engine search for multiple semantic vectors stored in the cloud server based on the specific semantic vector to select an approximate semantic vector corresponding to a video information, and sends the video information corresponding to the approximate semantic vector into the central controller of the electronic device; and, the central controller sends the video information to the human-machine interface to make the human-machine interface display the video information for the user.

7. An image search method of an electronic device, comprising:
providing a human-machine interface to receive an input of a user;
controlling an object detection circuit to perform an image object detection operation according to the input of the user transmitted from the human-machine interface to generate a specific image;
sending the specific image into an image-to-semantic circuit to control the image-to-semantic circuit to perform an image-to-semantic operation to perform an irreversible encryption encoding upon the specific image to generate a specific semantic vector;
sending the generated specific semantic vector into a cloud semantic search engine of a cloud server remotely connected to the electronic device, to make the cloud semantic search engine search for multiple semantic vectors stored in the cloud server based on the specific semantic vector so as to select an approximate semantic vector corresponding to an image information and sends image information corresponding to the approximate semantic vector to the human-machine interface; and
controlling the human-machine interface to display the image information for the user.

8. The image search method of claim 7, further comprising:
providing a local database to store multiple local semantic vectors;
further sending the generated specific semantic vector into a local semantic search engine of the local database, to make the local semantic search engine compare the multiple local semantic vectors stored in the local database based on the specific semantic vector to select another image information corresponding to another approximate semantic vector and send the another image information into the human-machine interface; and
controlling the human-machine interface to display both the image information and the another image information for the user.

9. The image search method of claim 7, wherein the input of the user comprises request information provided by the user, and the request information comprises a raw image and position information in the raw image requested by the user; and, the image search method further comprises:
performing the image object detection operation according to the requested raw image and the requested position information to extract an image of a specific object corresponding to the position information in the raw image as information of the specific image.

10. The image search method of claim 7, further comprising:
enhancing features of the specific image; and
performing the irreversible encryption encoding upon the enhanced specific image to extract a feature vector of the specific object as the specific semantic vector.

11. The image search method of claim 7, wherein the input of the user comprises request information provided by the user, and the request information comprises a raw image and position information in the raw image requested by the user, and the image search method further comprises:
providing a memory circuit to store image information;
providing an object detection model to extract multiple adjacent raw images from the memory circuit and extract multiple object images corresponding to the position information respectively in the multiple adjacent raw images to generate multiple object images based on the requested raw image and the requested position information; and
selecting a preferred object image from the multiple object images as information of the specific image.

12. The image search method of claim 7, wherein the input of the user comprises request information provided by the user, and the request information comprises a raw image frame, and the image search method further comprises:
providing a memory circuit to store image frame information;
providing a key frame extraction model to extract multiple adjacent raw image frames of the requested raw image frame from the memory circuit based on the requested raw image frame;
selecting a preferred raw image frame from the multiple adjacent raw image frames as information of the specific image;
sending the preferred raw image frame into the image-to-semantic circuit to control the image-to-semantic circuit to perform the image-to-semantic operation to perform the irreversible encryption encoding upon the preferred raw image frame to generate the specific semantic vector;
sending the generated specific semantic vector into the cloud semantic search engine of a cloud server remotely connected to the electronic device, to make the cloud semantic search engine search for multiple semantic vectors stored in the cloud server based on the specific semantic vector to select an approximate semantic vector corresponding to a video information;
sending the video information corresponding to the approximate semantic vector into the central controller of the electronic device; and
sending the video information to the human-machine interface to make the human-machine interface display the video information for the user.
